(19) United States
(12) Patent Application Publication
(10) Pub. No.: US 2015/0014347 A1
(43) Pub. Date: Jan. 15, 2015

(54) MOUNTING APPARATUS FOR WAREHOUSE OF VENDING MACHINE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: YUN-LUNG CHEN, New Taipei (TW); GANG SU, Wuhan (CN); WEI-YONG MA, Wuhan (CN); REN-XI DOU, Wuhan (CN); LIANG TU, Wuhan (CN); ZHI-WU XIA, Wuhan (CN)

(21) Appl. No.: 14/326,694

(22) Filed: Jul. 9, 2014

(30) Foreign Application Priority Data
Jul. 11, 2013 (CN) 2013102898005

(51) Int. Cl. G07F 11/04

(52) U.S. Cl. CPC G07F 11/04
USPC 221/154

(57) ABSTRACT

Mounting apparatus for holding goods containers in a vending machine includes a rack with a cover. At least two containers (warehouses) comprise a center warehouse with a first blocking portion and a left warehouse with a second blocking portion. A sliding member includes a flange. The sliding member can be in a a first position or in a second position. In the first position, the flange abuts the second blocking portion and is disengaged from the first blocking portion, allowing the center warehouse to be moved out of the rack but so preventing the left warehouse from also moving out of the rack. In the second position, the flange abuts the first blocking portion and is disengaged from the second blocking portion, allowing the left warehouse to be moved out of the rack but so preventing the right warehouse from also moving out of the rack.

### FIELD

The present disclosure relates to mounting apparatuses, and more particularly to a mounting apparatus for securing warehouses in an automatic vending machine.

### BACKGROUND

Vending machines can operate twenty four hours a day. Various merchandise, for example cold drinks or hot drinks, can be stored in a plurality of warehouses of a rack of the vending machine.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus for securing three warehouses.

FIG. 2 is an enlarged view of a circled portion II of the mounting apparatus of FIG. 1.

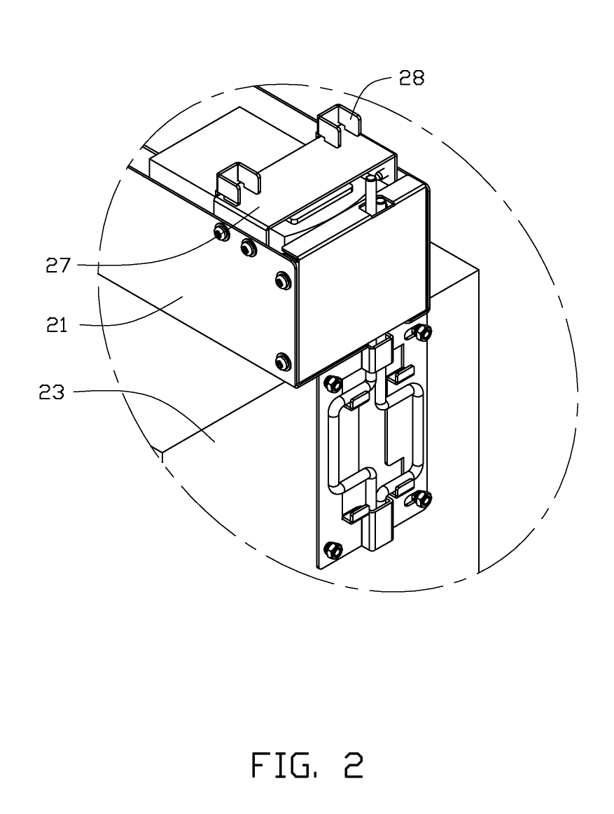

FIG. 3 is an isometric view of a sliding member of the mounting apparatus.

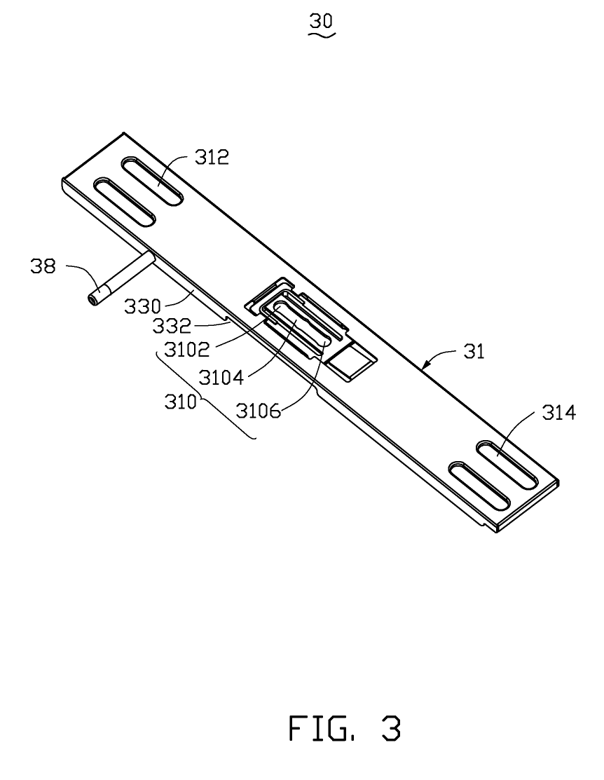

FIG. 4 is an assembled view of the mounting apparatus and the three warehouses of FIG. 1.

FIG. 5 is similar to FIG. 4, but the first sliding member is located in a first position.

FIG. 6 is an enlarged view of a circled portion VI of the mounting apparatus and the three warehouses of FIG. 5.

FIG. 7 is a front view of the mounting apparatus and the three warehouses of FIG. 5.

FIG. 8 is similar to FIG. 4, but the first sliding member is located in a second position.

FIG. 9 is an enlarged view of a circled portion IX of the mounting apparatus and the three warehouses of FIG. 8.

FIG. 10 is a front view of the mounting apparatus and the three warehouses of FIG. 8.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

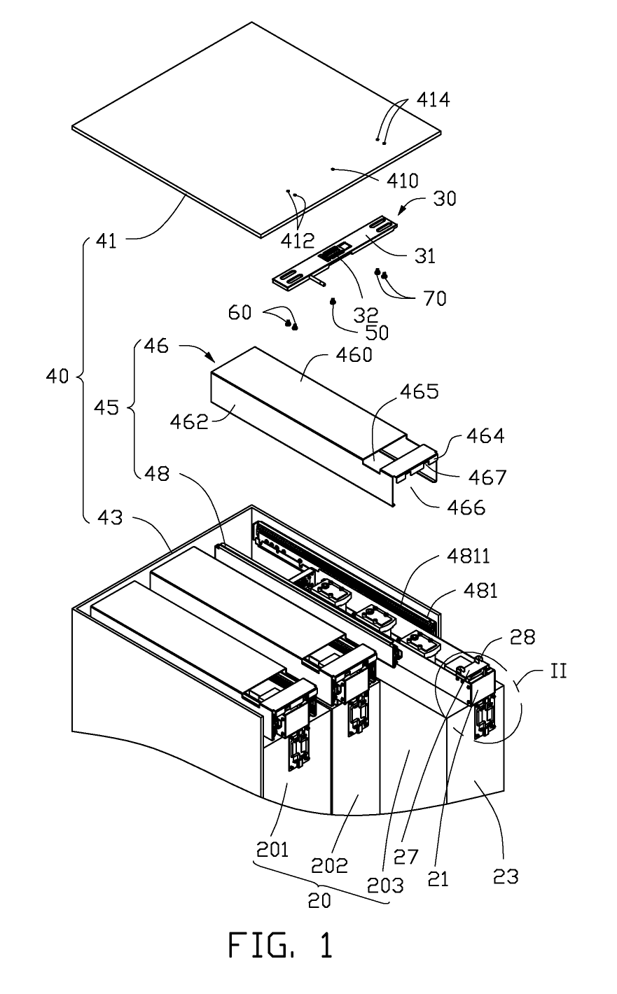

FIG. 1 illustrates a mounting apparatus in an automatic vending machine (not shown). The mounting apparatus comprises a rack 40, three warehouses 20 located in the rack 40, and a sliding member 30 slidably attached to the three warehouses 20. The three warehouses 20 store merchandise and can be arranged in a line with designations of left warehouse 201, center warehouse 202, and right warehouse 203.

The rack 40 comprises a main body 43, three mounting boxes 45 secured to the main body 43, and a cover 41 on the main body 43. The cover 41 defines five positioning holes, such as a first positioning hole 410, a pair of second positioning holes 412, and a pair of third positioning holes 414. Each mounting box 45 can be located on each warehouse 20 and each comprises a top portion 46 and a bottom portion 48 secured to the warehouse 20. The top portion 46 comprises a top panel 460 and two side panels 432 extending from opposite edges of the top panel 460. Three extending tabs 464 extend from a free edge of the top panel 460, and an engaging gap 467 is defined between every two adjacent extending tabs 464. A receiving portion 465 is defined in the top panel 460. An entrance 466 is defined in the top portion 46. In one embodiment, the receiving portion 465 can be an opening communicating with the entrance 466. The bottom portion 48 can be two parallel panels 481, and a sliding rail 4811 is located on each panel 481.

Each of the left warehouse 201, the center warehouse 202, and the right warehouse 203 comprise a holding portion 23 and a mounting portion 21 located on the holding portion 23. The mounting portion 21 is slidably secured to the sliding rail 4811 and comprises a mounting panel 27. Two blocking portions 28 are located on the mounting panel 27 and correspond to the engaging gaps 467.

The sliding member 30 can be slidably received in the receiving portion 465 and comprises a sliding panel 31 and an operating portion 38 extending from the sliding panel 31. A plurality of sliding slots is defined in the sliding panel 31. The plurality of sliding slots comprises a first sliding slot 310, a pair of second parallel sliding slots 312, and a pair of third parallel sliding slots 314. The first sliding slot 310 comprises a left portion 3102, a center portion 3104, and a right portion 3106. Two flanges 330 extend from the sliding panel 33, and a cutout 332 is defined between the two flanges 330.

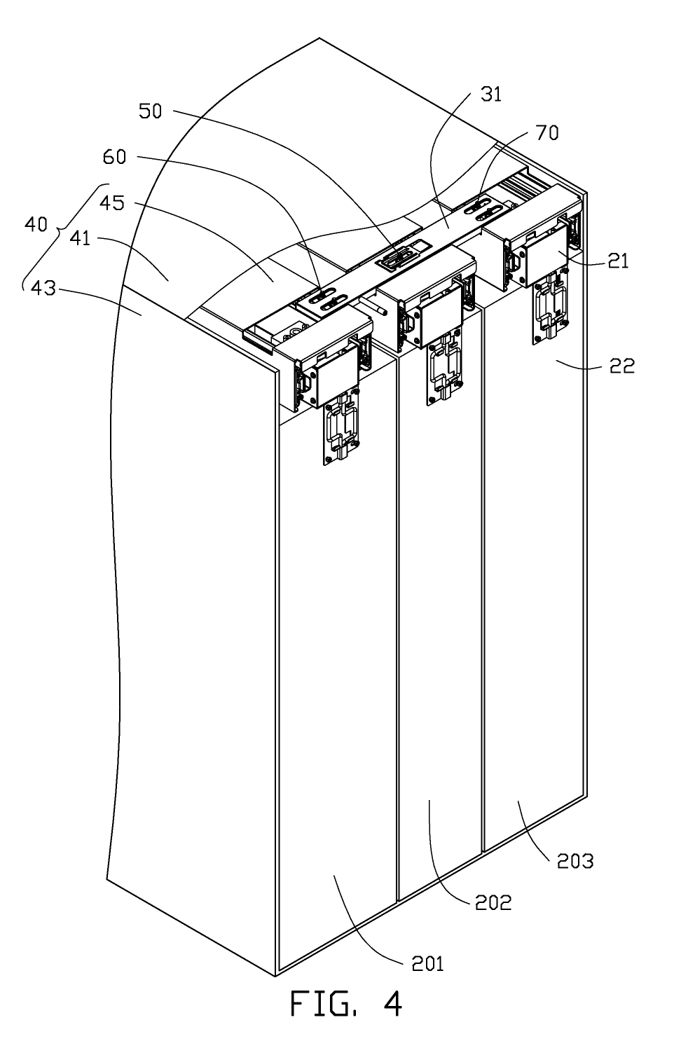

FIG. 4 illustrates an assembly of the mounting apparatus. The sliding member 30 is received in the three receiving portions 465. A first positioning member 50 extends through the first sliding hole 310 and the first positioning hole 410. A pair of second positioning members 60 extends through the pair of second sliding slots 312 and the pair of second positioning holes 412. A pair of third positioning members 70 extends through the pair of third sliding slots 314 and the pair of second positioning holes 414. Thus, the sliding member 30 is slidably secured to the cover 41, and each blocking portions 28 is received in each engaging gap 467 and blocked by the flanges 330, preventing the three warehouses 20 from moving out of the main body 43.

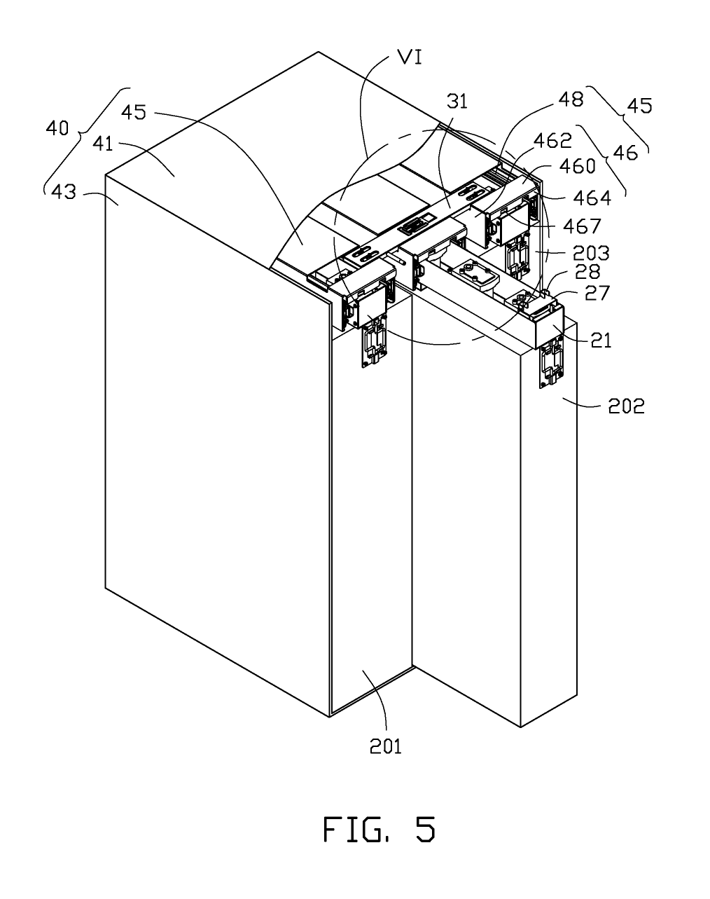

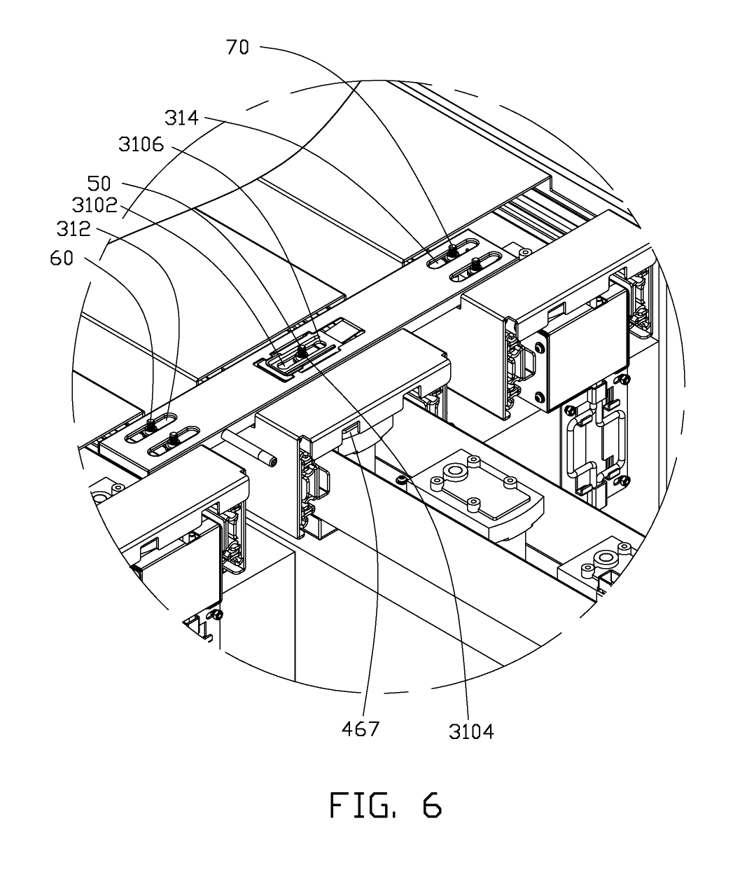

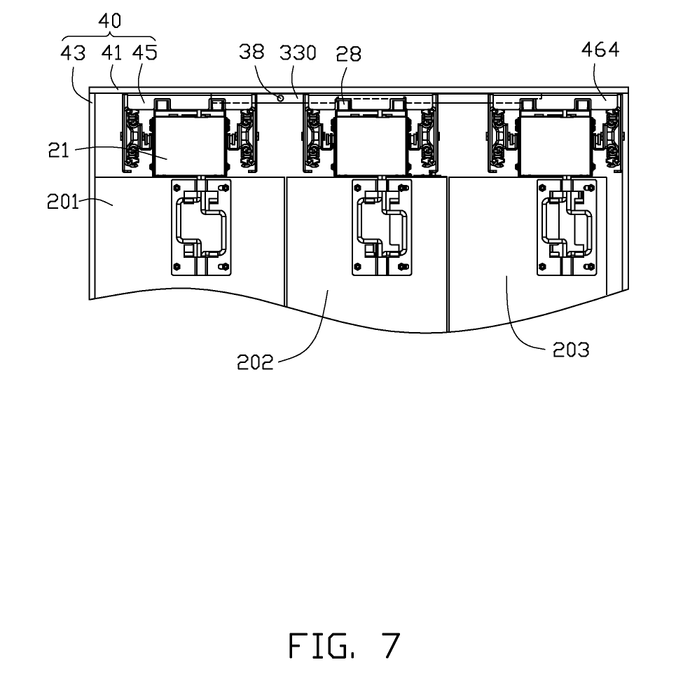

FIGS. 5-7 illustrate in use, of pulling out the center warehouse 202, the operating portion 38 is operated to move the main body 31 in a first direction that is substantially parallel to the cover 41. The first positioning member 50 is slid in the first positioning slot 310, the pair of second positioning members 60 is slid in the pair of second positioning slots 312, and the pair of third positioning members 60 is slid in the pair of third positioning slots 314, until the first positioning member 50 is located in the center portion 3104. At this time, the two blocking portions 28 of the center warehouse 202 are not blocked by the two flanges 330 (see FIG. 7), but the blocking portion 28 of the left warehouse 201 and the blocking portion 28 of the right warehouse 203 are blocked by the two flanges 330 (see FIG. 7). Thus, the two blocking portions 28 of the center warehouse 202 can extend through the cutout 332 and the engaging gaps 467. When the center warehouse 202 is pulled out of the main body 43, the left warehouse 201 and the right warehouse 203 cannot also be pulled out of the main body 43.

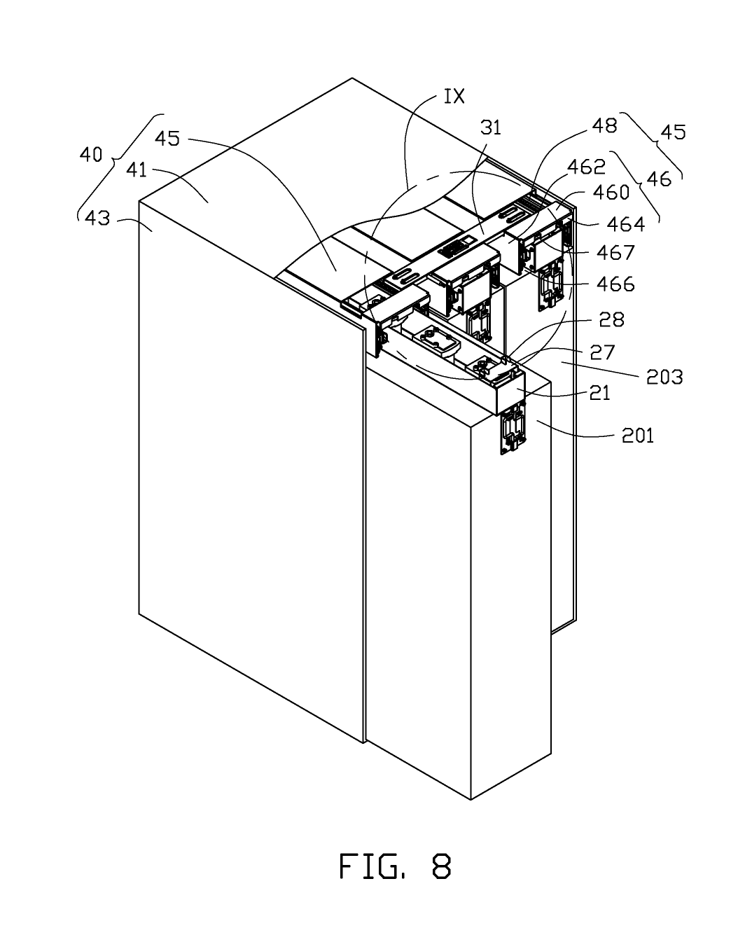

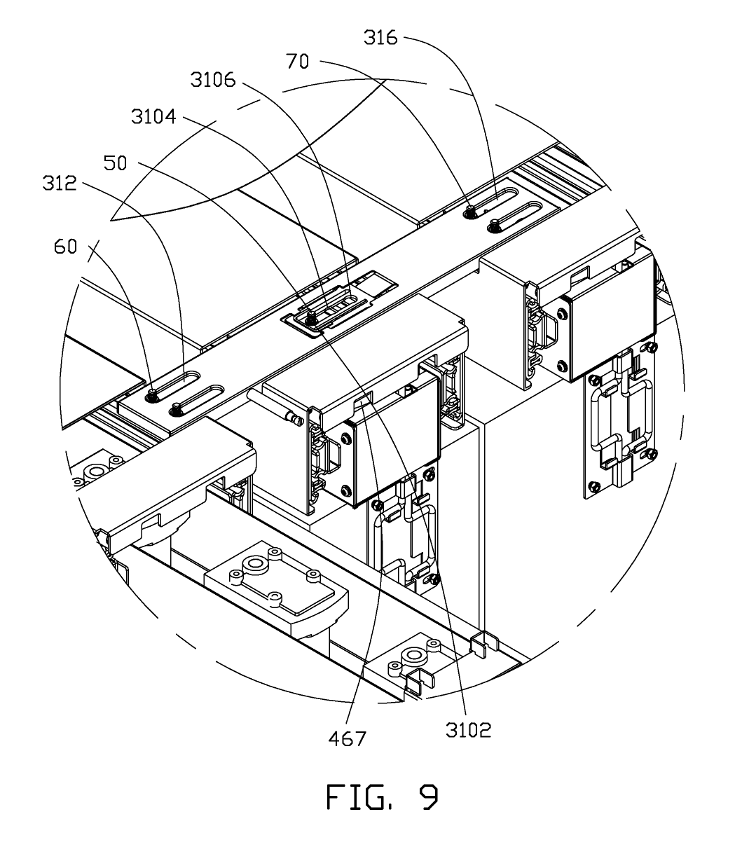

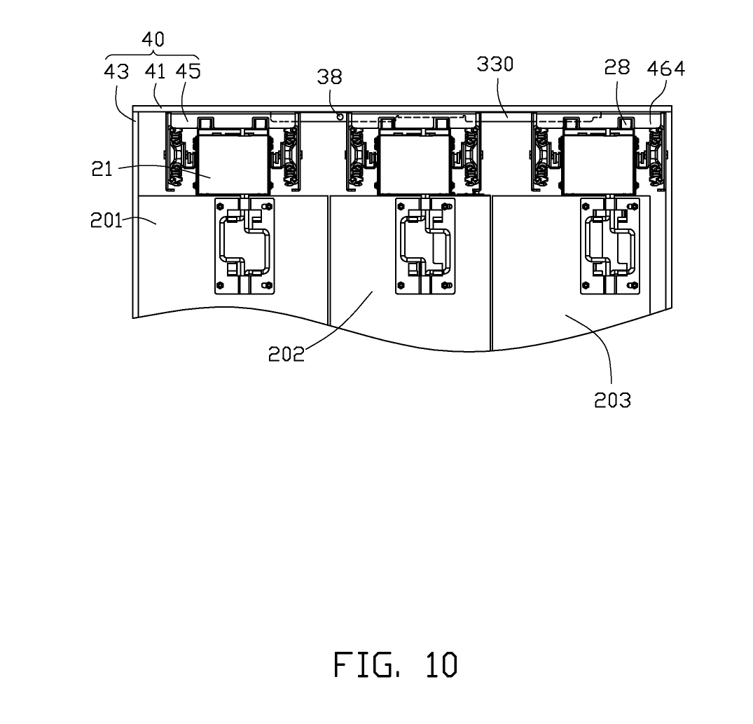

FIGS. 8-10 illustrate in use of pulling out the left warehouse 201; the operating portion 38 is operated to move the main body 31 in the first direction. The first positioning member 50 is slid in the first positioning slot 310, the pair of second positioning members 60 is slid in the pair of second positioning slots 312, the pair of third positioning members 60 is slid in the pair of third positioning slots 314, until the first positioning member 50 is located in the right portion 3106. At this time, the blocking portion 28 of the left warehouse 201 is not blocked by the two flanges 330 (see FIG. 10), but the blocking portions 28 of the center warehouse 202 and the blocking portion 28 of the right warehouse 203 are blocked by the two flanges 330 (see FIG. 10). Thus, the blocking portion 28 of the left warehouse 201 can extend through the engaging gaps 467. When the left warehouse 201 is pulled out of the main body 43, the center warehouse 202 and the right warehouse 203 cannot also be pulled out of the main body 43.

Similarly, when pulling out the right warehouse 203, the operating portion is operated to move the main body 31 in the first direction and towards the left warehouse 201. The first positioning member 50 is slid in the first positioning slot 310, the pair of second positioning members 60 is slid in the pair of second positioning slot 312, the pair of third positioning members 60 is slid in the pair of third positioning slot 314, until the first positioning member 50 is located in the left portion. At this time, the blocking portion of the right warehouse is not blocked by the two flanges, the blocking portions 28 of the center warehouse 202 and the blocking portion of the left warehouse 203 are blocked by the two flanges. Thus, the blocking portion of the right warehouse 203 can extend through the engaging gaps. When the right warehouse 203 is pulled out of the main body, the center warehouse 202 and the left warehouse 201 cannot also be pulled out of the main body.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure. The disclosed embodiments are illustrative only, and should not be read to limit the following claims.

What is claimed is:

1. A mounting apparatus comprising:
a rack comprising a cover and a mounting box;
a center warehouse slidably attached to the mounting box;
a first block portion is located on the center warehouse; and
a sliding member slidably attached to the cover and comprising a flange abutting the first block portion,
wherein the sliding member is slidably relative to the cover to disengage the flange from the first blocking portion, so that the center warehouse is moveable out of the rack.

2. The mounting apparatus of claim 1, wherein the sliding member is slidable in a direction that is substantially parallel to the cover.

3. The mounting apparatus of claim 1, further comprising a first positioning member wherein the securing member defines a first positioning slot, the first positioning member is slidably received in the first positioning slot and secured the cover.

4. The mounting apparatus of claim 3, wherein the first positioning slot comprises a center portion, when the first flange is disengaged from the first blocking portion, the first positioning member is located on the center portion.

5. The mounting apparatus of claim 4, further comprising a left warehouse slidably attached to the mounting box, wherein a second block portion is located on the center warehouse, when the flange is disengage from the first blocking portion, the flange abuts the second blocking portion for prevent the left warehouse from moving out of the rack.

6. The mounting apparatus of claim 5, wherein the first positioning slot further comprises a right portion, when the first positioning member is located in the right portion, the flange is disengaged from the second blocking portion for allowing the left warehouse to move out of the rack, and the flange abut the first blocking portion for prevent the center warehouse from moving out of the rack.

7. The mounting apparatus of claim 6, further comprising a right warehouse slidably attached to the mounting box, wherein a third block portion is located on the center warehouse, wherein the first positioning slot further comprises a left portion opposite to the right portion, the center portion is located between the left portion and the right portion, when the first positioning member is located in the left portion, the flange is disengaged from the third blocking portion for allowing the left warehouse to move out of the rack, and the flange abut the first blocking portion and the second blocking portion for prevent the center warehouse and the left warehouse from moving out of the rack.

8. The mounting apparatus of claim 1, wherein the mounting box comprises a top portion, the top portion comprises a receiving portion, and the sliding member is slidably received in the receiving portion.

9. The mounting apparatus of claim 8, wherein the top portion comprises a top panel, the receiving portion is defined in the top panel, a plurality of extending tabs is located on the top panel, an engaged gap is defined every two adjacent extending tabs, and the first blocking portion is positioned in the engaging gap.

10. The mounting apparatus of claim 1, wherein the sliding member comprises a sliding panel substantially parallel to the cover, and the flange is substantially perpendicular to the sliding panel.

11. A mounting apparatus comprising:
a rack comprises a cover and a mounting box;
a center warehouse slidably attached to the mounting box;
a first block portion is located on the center warehouse;
a left warehouse slidably attached to the mounting box;
a second block portion is located on the left warehouse; and
a sliding member slidably attached to the cover and comprising a flange;
wherein the sliding member is slidably relative to the cover between a first position and a second position, when the sliding member is located in the first position, the flange abuts the second blocking portion and disengaged from the first blocking portion, for allowing the center warehouse out of the rack and preventing the left warehouse from moving out of the rack; when the sliding member is located in the second position, the flange abuts the first blocking portion and disengaged from the second blocking portion, for allowing the left warehouse out of the rack and preventing the right warehouse from moving out of the rack.

12. The mounting apparatus of claim 11, wherein the sliding member is slidable in a direction that is substantially parallel to the cover.

13. The mounting apparatus of claim 11, further comprising a first positioning member wherein the securing member defines a first positioning slot, the first positioning member is slidably received in the first positioning slot and secured the cover.

14. The mounting apparatus of claim 13, wherein the first positioning slot comprises a right portion and a center portion, when t the sliding member is located in the first position, the first positioning is located in the right portion, and when the sliding member is located in the second position, the first positioning is located in the center portion.

15. The mounting apparatus of claim 14, further comprising a right warehouse slidably attached to the mounting box, wherein a third block portion is located on the center warehouse, wherein the first positioning slot further comprises a left portion opposite to the right portion, the center portion is located between the left portion and the right portion, when the first positioning member is located in the left portion, the flange is disengaged from the third blocking portion for allowing the left warehouse to move out of the rack, and the flange abut the first blocking portion and the second blocking portion for prevent the center warehouse and the left warehouse from moving out of the rack.

16. The mounting apparatus of claim 11, wherein the mounting box comprises a top portion, the top portion comprises a receiving portion, and the sliding member is slidably received in the receiving portion.

17. The mounting apparatus of claim 16, wherein the top portion comprises a top panel, the receiving portion is defined in the top panel, a plurality of extending tabs is located on the top panel, an engaged gap is defined every two adjacent extending tabs, and the first blocking portion is positioned in the engaging gap.

18. The mounting apparatus of claim 11, wherein the sliding member comprises a sliding panel substantially parallel to the cover, and the flange is substantially perpendicular to the sliding panel.
